(19) United States
(12) Patent Application Publication
(10) Pub. No.: US 2006/0293969 A1
(43) Pub. Date: Dec. 28, 2006

(54) Method and System for Pre-Loading Media Players

(76) Inventors: Sean Barger, Mill Valley, CA (US); Brett Durrett, Berkeley, CA (US); David C. Salmon, Portland, OR (US)

Correspondence Address: GLENN PATENT GROUP, 3475 EDISON WAY, SUITE L, MENLO PARK, CA, 94025, US

(21) Appl. No.: 11/427,323

(22) Filed: Jun. 28, 2006

Related U.S. Application Data
(60) Provisional application No. 60/694,869, filed on Jun. 28, 2005.

(51) Int. Cl. G06Q 30/00; G06F 17/00

(52) U.S. Cl. 705/26; 705/400

(57) ABSTRACT

A vendor provides virtual storefront from which customers purchase digital media devices via an interactive network connection. The customer authenticates their media by means of a client application supplied by the vendor. The customer runs the application, which prompts the customer to insert the customer's media (compact disks) into the client computer. Using challenge/response authentication, the client validates that the media is authentic. The authenticated media is added to a repository of customer-owned media. After purchase, the customer, selects which of the customer's previously-authenticated media are to be installed on the device. A device is withdrawn from inventory and customized by installing the selected media. The pre-loaded device is shipped to the customer, sparing the customer the necessity of spending many hours installing the customer's media collection on the digital media player.

### CROSS REFERENCE TO RELATED APPLICATIONS

This application claims benefit of U.S. provisional patent application Ser. No. 60/694,869, filed Jun. 28, 2005, which is incorporated herein in its entirety be this reference thereto.

### BACKGROUND OF THE INVENTION

1. Field of the Invention

The invention relates to production and delivery of digital assets. More particularly, the invention relates to methods and systems for pre-loading digital media players.

2. Background Information

Not long after the earliest sound reproduction technologies were developed in the late 19^{th} and early 20^{th} centuries, there began attempts to miniaturize the technologies and make them portable. Such attempts gave rise to the portable phonographs and portable radios of the mid-20^{th} century. Eventually, digital electronics found its way into sound reproduction, resulting in compact disc technology in the late 20^{th} century. Portable CD players and minidisc players began to appear shortly after.

The relatively recent development of digital media encoding technology has made it possible to create high fidelity copies of digital media in the form of highly compact and easily transferable data files. For example, it may require as much as 1400 megabits to represent only one second of CD-quality audio. However, using the popular MP3 (MPEG Audio Layer III) format, the original sound data from a CD may be reduced by a factor of twelve without an appreciable loss in sound quality. While MP3 is a widely known codec (coder-decoder), it is by no means the only one. The availability of such media codecs, combined with advances in storage technology, has led to the proliferation of digital media players. The first non-mechanical digital audio player appeared in the marketplace in 1997.

The popularity of digital media players and the ease with which encoded media files could be transferred from one party to another across computer networks, such as the Internet, complicated enforcement of copyright protection by the owners and creators of the works copied, and helped to give rise to the new field of digital rights management (DRM). A primary tool in the DRM field is DRM software, which limits the end-user's ability to consume or use media in a way which violates copyright.

Most, if not all digital media players can play music that has been ripped—copied—from CDs via computer. In addition to ripped CD tracks, many digital audio players can accept downloaded music form online music stores. However, due to the complexity of digital rights management (DRM), not all media file formats will play on all digital audio players. Some proprietary file formats also restrict users from transferring media to non-compatible digital media players. Additionally, when an end-user purchases a new media player, the process of ripping tracks from CDs and DVDs, encoding them, and copying them to the new player is very time-consuming.

### SUMMARY OF THE INVENTION

In recognition of the above problems, a system and method for pre-loading digital media players simplifies and streamlines the process of loading media onto a digital media player in a manner that enforces copyright protection for the media in question.

A vendor provides a networked e-commerce site equipped with, for example, a shopping cart, from which customers may purchase digital media devices. Before purchasing, or at the time of purchase, a life-time account is created for the end-user. Either before or after purchase of the device, the customer authenticates their media. Media authentication is performed by means of a client application supplied by the vendor. The customer runs the application, which prompts the customer to insert the customer's media, such as CD's (compact disks) into the computer running the client. Using challenge/response authentication with a central server, the client validates that the media is authentic. The media is then added to a repository of customer-owned media. After purchase, the customer, via a web interface, selects which of the customer's previously-authenticated media are to be installed on the device. Optionally, the customer may purchase additional media for installation, for example, from third parties. A device is withdrawn from inventory and customized by installing the selected media. Finally, the pre-loaded device is shipped to the customer, sparing the customer the necessity of spending many hours installing the customer's media collection on the digital media player.

An alternate embodiment of the invention allows a customer to load media into a digital media player acquired from a third party.

### BRIEF DESCRIPTION OF THE DRAWINGS

FIG. 1 is a schematic of a network architecture of a system for pre-loading digital media devices;

FIG. 2 provides a flow diagram of a method for pre-loading digital devices;

FIG. 3 shows a screen shot of a web-based virtual store with a device in a shopping cart;

FIG. 4 shows a screen shot of a customer's list of authenticated media, before authentication;

FIG. 5 is a screen shot of a customer login to a media authentication program on a computing device;

FIG. 6 is a screen shot from an authentication server authenticating a customer;

FIG. 7 is a screen shot showing a customer authenticated to use authentication program on a computing device;

FIG. 8 is a screen shot showing a CD authenticated and added to the customer's list of authenticated media;

FIG. 9 is a screen shot of an authentication server reflecting satisfied challenge / response validation;

FIG. 10 is a screen shot showing a list of authorized media reflecting successful authentication of two CDs;

FIG. 11 is a screen shot of a user interface that allows a customer to alter media format;

FIG. 12 is a screen shot showing a shopping cart containing an order for a digital media device and media;

FIG. 13 is a screen shot of a customer order available to a synchronization server;

FIG. 14 is a screen shot from the synchronization server showing device automatically detected, drive initialized and firmware being installed;

FIG. 15 is a screen shot showing the synchronization server requesting assets from asset servers;

FIG. 16 is a screen shot showing the asset server with examples of assets that are cached and in need of generation;

FIG. 17 shows a completed load order on the synchronization server.

### DETAILED DESCRIPTION

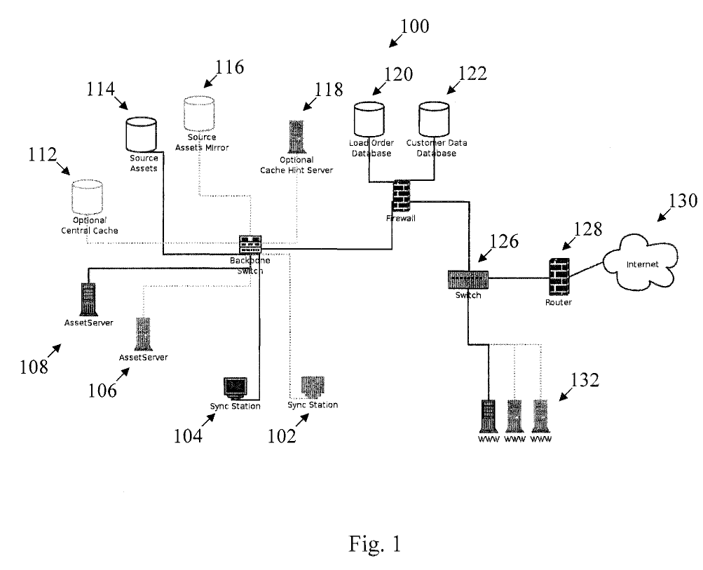

Turning now to FIG. 1, a schematic diagram of the network architecture 100 of a system for preloading digital media players is shown. One embodiment of the system 100 includes one or more of the following components:
synchronization servers 104, 102;
asset servers 106, 108;
backbone switch 110;
source asset server, mirror 114, 116;
optional cache hint server 118;
load order database 120;
customer data database 122;
firewall 124;
switch 126;
router 128; and
www servers 132.

One or more web servers 132 provide a vendor website. A customer, wishing to purchase a digital media player, accesses the vendor website housed on a web server 132 via the Internet 130. The ordinarily-skilled practitioner will readily recognize that the Internet 130 is a global computer network that connects computers everywhere. While one embodiment of the invention is implemented over the Internet, the invention is compatible with most commonly-known networking technologies. Thus, other embodiments of the invention are implemented in other network environments, such as, for example the newly-emerging alternatives to the Internet. The vendor web site hosts one or more e-commerce-related software applications such as a shopping cart, by which the customer places an order for goods offered for sale by the vendor, including, for example, at least one model or brand of digital media player. Additionally, an embodiment of the invention provides other customer-facing connectivity, such as the software application, described below, with which a customer purchasing a pre-loaded digital media player authenticates the media to be pre-loaded onto the newly-purchased digital media player.

A customer accesses the web server via a web client (not shown). The web client may be a conventional web browser running on for example, a desktop or laptop computer or handheld device. Additionally, the client may be a web-enabled wireless device such as a cell phone or a personal digital assistant.

In one embodiment, the system 100 includes one or more or routers 128 and/or one or more switches 126. The ordinarily-skilled practitioner will readily understand that the switches and/or routers are included to provide network routing between the Internet and the production network of the system 100. In an alternative embodiment of the system 100, one or both of the switches and/or routers are omitted.

The system 100 further includes one or more load order databases 120 and one or more customer data databases 122. The load order database is a collection of data describing media assets that need to be processed, typically for delivery to a customer. More will be said about such load orders and media assets herein below. The customer data database is a collection of data associated with customers, for example customer records containing shipping address, billing address, order history and so on. While one embodiment of the invention utilizes relational databases for both the customer data database and the load order database, alternate database models, such as object-oriented databases, flat files and delimited text files are within the scope of the invention. An embodiment of the invention also includes one or more firewalls 124 interposed between the Internet 130 and the production network of the system 100. An alternative embodiment of the invention dispenses with the firewall, instead relying on other methods of providing security for the system.

The system 100 also includes one or more synchronization servers—sync stations—102, 104, that take load orders and distribute the processing jobs to asset servers 114, 116 and then load processed assets onto a media storage device, for example the memory or disk drive of a digital media player.

Additionally, the system includes one or more source asset repositories 114, 116 and repository mirrors. A source asset repository is a collection of media used as a source to create the processed assets that are loaded onto the storage media by the synchronization server 104,102. An embodiment of the invention mirrors the source assets repository, providing an additional copy for reliability and efficiency. There are several ways the data can be placed on the source assets servers, including, but not limited to, “ripping” data from another data source (i.e. a compact disc), acquiring high-quality source assets from a licensing company, downloading the data from any third party or even having customers upload assets. In addition, an embodiment of the inventions makes it possible for asset servers to request assets from a source other than the source assets server, for example, by pointing to a URL.

An asset server 108, 106 retrieves source assets from the source assets repository 114, 116 for loading onto a storage medium. In such case, in fulfilling a load order, the asset server 108, 106 returns a copy of the digital assets that has been given additional processing. The additional processing is described in greater detail herein below and may include encoding to a format different from the source format. In the case of an asset that needs no additional processing, for example, if the source format and the target format are the same, the asset server returns an exact copy of the digital asset.

Additionally, an embodiment of the invention may include a central cache 112 that provides temporary storage for assets that have been processed and that may be used for additional processing. A cache hint server 118 maintains a record of which asset servers are most likely to have previously processed assets cached locally, which helps to minimize the necessity of processing a digital asset to fulfill an order if it has been previously processed and locally cached to fulfill a previous order.

A backbone switch 110 provides connectivity and coordinates data flow between all elements of the production network.

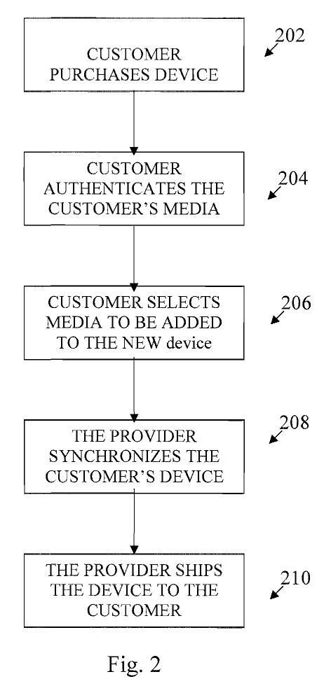

FIG. 2 shows a flow diagram of an embodiment of a method for preloading digital media players 200. As shown, the invented method involves one or more of the following steps:
A customer purchases a device from the vendor (202);
The customer authenticates the customer's media (204);
The customer selects media to be added to the new device (206);
The vendor synchronizes the customer's device (208); and
The vendor ships device to the customer.

Each of the foregoing steps is described in greater detail herein below.

The Customer Purchases a Device from the Vendor
Using web / shopping cart tools, customer purchases device from the vendor's web site; and
If one does not already exist, an account is created.

Using an interactive network connection (for example, a web browser from a PC, a WAP (wireless access protocol) deck from a mobile phone or any other network-connected device) the customer accesses a virtual store, shopping cart and a list of media that the customer has the right to use (known as “authenticated media”). The virtual store allows the customer to browse media devices, media and related accessories. The virtual store may include access to other features such as offering special promotions or updating the customer's media library with higher quality media. Another embodiment of the invention is possible wherein the customer acquires a digital media player from a third party. A new customer connects to the vendor and creates an account that records information necessary to identify that customer.

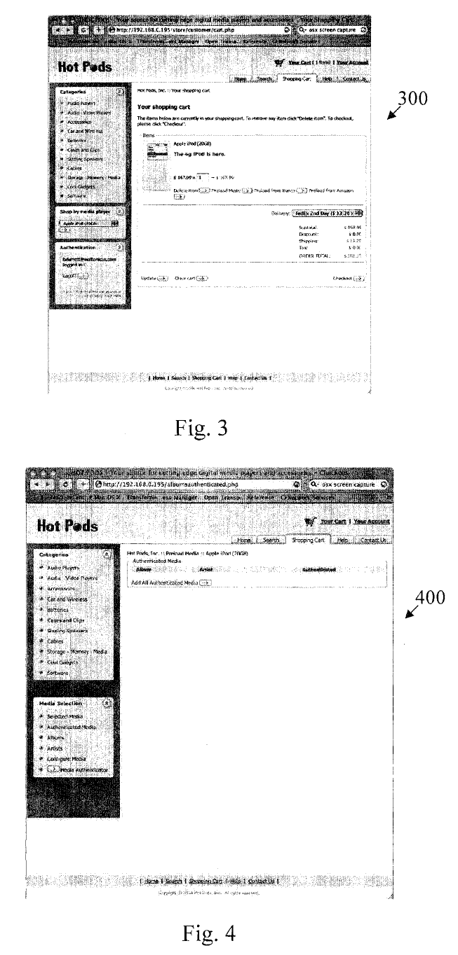

A mechanism for validating the user when he or she connects to the network (for example a password, shared-keys or hardware authentication) is also established at the time of account creation. In one embodiment of the invention, the account is a life time account. In another embodiment, the life or duration of the account may be limited in one way or another, for example to an arbitrary, predetermined amount of time. The customer may also be required to provide reasonable proof of the customer's identify, for example, by providing information that may include a credit card in the customer's name that the vendor can authenticate with the card issuer, an electronic certificate signed by a recognized certificate authority. Other methods of verifying the customer's identity will occur to the ordinarily-skilled practitioner and are within the scope of the invention. FIG. 3 is a screen shot from a web-based virtual store showing a device in the shopping cart 300. In another embodiment of the invention, the media device is purchased from a third party rather than from the vendor.

The Customer Authenticates the Customer's Media
A client application is provided to the customer via the website;
The customer runs the application, which instructs them to insert their media (compact discs) into their computer;
Using challenge / response authentication with the vendor's servers, the application validates that the media is authentic;
The media is permanently added to the vendor's database of customer-owned media.
The customer adds authenticated media to the account through a mechanism that provides reasonable assurance that the customer has the rights to use the media. This might include certification from a trusted third-party that the customer has purchased the media, a purchase of the media use rights from the vendor directly or authentication that the customer is in possession of the media.

If the customer wishes to authenticate media that they are in possession of, a program is executed that has the ability to read the media and respond to a challenge/response request from a networked server. The program may be in the form of a standard application, an applet, code embedded in the networked device or any other method of executing binary code from a network connection. The program may operate on any device, it does not require that the device match one that is being purchased or has been purchased from the vendor (i.e. a customer may authenticate their media on their PC for use in a media player being purchased from the vendor). FIG. 4 provides a screen shot of a blank list 400 of media for authentication

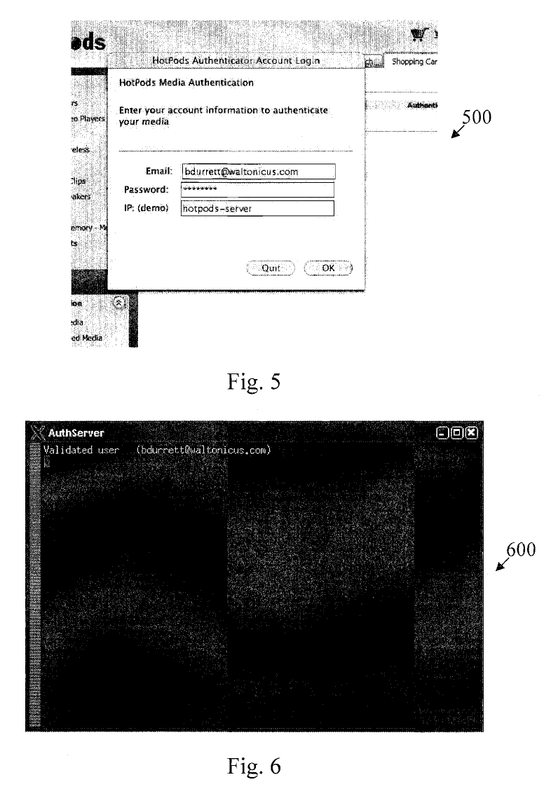

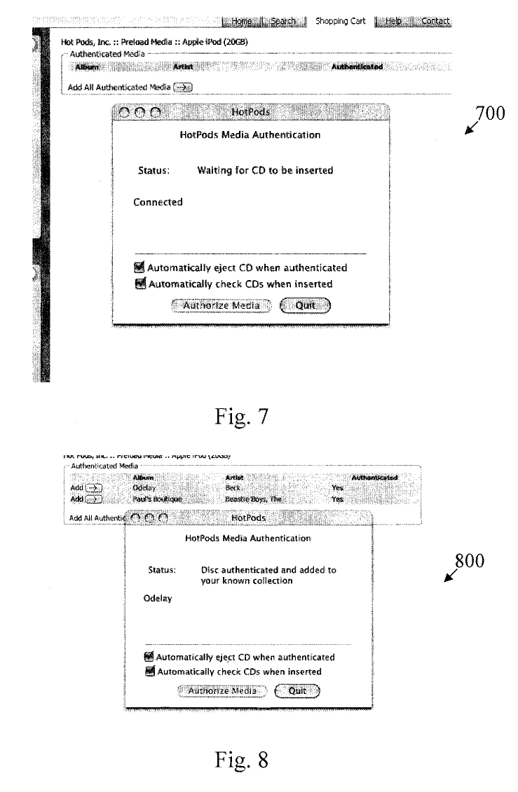

The media authentication program is executed by the customer. The customer uses the authentication method established when creating his or her account to confirm the customer's identity. To increase the security, device-specific or connection-specific information may be recorded and required before the customer is authenticated. FIG. 5 shows a Customer login screen 500 to the media authentication program. FIG. 6 is a screenshot 600 showing confirmation that the system has validated the user. FIG. 7 is a screen shot of a text box prompting the validated user to insert a CD for authentication.

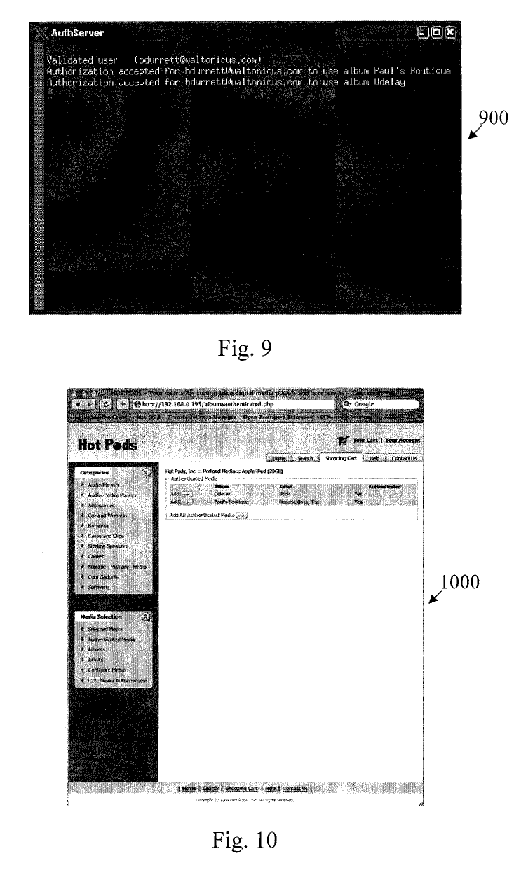

The customer provides the authentication program access to the customer's media and, using a challenge-response mechanism, the media is authenticated by the vendor's authentication server. The form of the challenge/response can vary as needed for the media type, legal requirements, media variations or many other factors. Possible forms include checksum of random segments of data from the media, waveform comparisons, image comparisons, serial numbers or Digital Rights Management authorization. Other forms of the challenge/response mechanism will occur to the ordinarily-skilled practitioner and are within the scope of the invention. As shown in FIG. 8, as each CD authenticated and added to the customer's list of authenticated media, a confirmation 800 is presented that the CD has been authenticated. As shown in FIG. 9, the authentication server also reflects a satisfied challenge/response authentication. FIG. 9 shows the list of authorized media 900 reflecting successful authentication of two CDs.

Customer Selects Media to be Added to the Device

The customer uses the integrated store/music browser to select from their previously-authenticated media for addition to the new device;
Optionally, the music browser allows customers to select new music to purchase and include with the new device; and
Additional music may be selected via affiliates or partners, such as iTunes or Amazon.

The customer is able to connect to the virtual store and order devices to be delivered with their authenticated media already installed on the device. For each device to be ordered, the customer selects some or all of their authenticated media to be included with that device. The interface is provided through any media-browsing interface that allows the selection of media as an entire collection, individual assets or in logical groups (i.e. playlists, albums, artists, directors, studios). Media may also be included via partners of the vendor that have the ability to sell media to the customer and provide authentication to the vendor. For example, while connected to the virtual store an option may allow for a purchase of music from AMAZON (either physical media or download rights) and the authentication is provided to the vendor at the time of purchase.

The virtual store provides the suggested format for the customer's media, taking into account the target device's features, total amount of media to be included on the device, DRM requirements, customer preferences or any other factors that might be relevant. Optionally, the customer may choose to alter the recommended media output. FIG. 10 shows a user interface 1000 by which the customer can alter the media format.

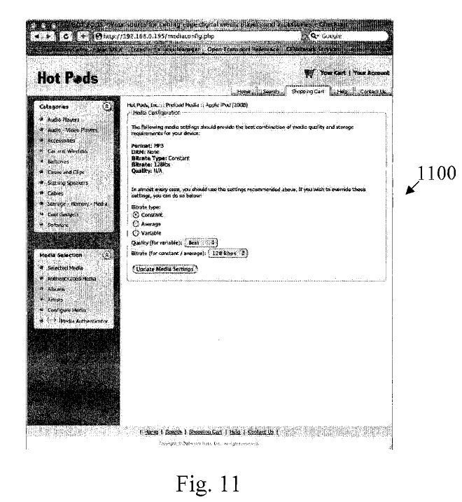

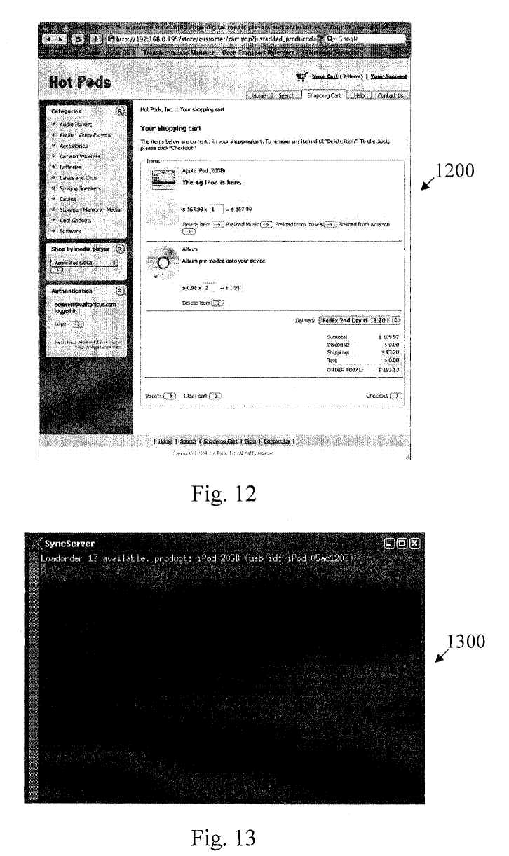

After the customer finalizes the media order, charges associated with the media order are calculated and the customer has the ability to complete their order that includes a device and media for that device. FIG. 11 show a shopping cart 1100 with the order for device and media.

The Vendor Synchronizes Customer's Device
Shipping employees are notified that a new load order is available, with the device type;
A device is pulled from inventory, plugged into a synchronization server and its serial number/model is validated;
The synchronization server requests each asset from any available asset server (can be done in parallel);
When all assets have been returned, the synchronization server performs any final customization and notifies the shipping employee that the device is ready.

The customer's completed order is fulfilled by the vendor by obtaining the requested device, preparing the device for use, loading the customer's selected media onto the device and shipping the device to the customer.

In one embodiment, the device is obtained from the vendor's inventory. In a further embodiment, the device is obtained from a third party. The requesting of the device from a third-party may be automated via an ordering system that is integrated with the virtual store.

A list of orders that are ready to be fulfilled and the devices are accessible at synchronization servers, computers or other machines that are able to connect to and interact with the devices. A synchronization server may attach to multiple devices at once. In one embodiment, a synchronization server may be compatible with all available devices. In an alternative embodiment, a synchronization server may be compatible with certain device types but not others. In the latter embodiment, only compatible devices are displayed. FIG. 13 shows a display 1300 of a customer order available to the synchronization server for processing.

Various embodiments of the invention use different modes and or media to connect the synchronization server to the device, for example: USB (universal serial bus, FIREWIRE (IEEE 1394), Serial cable, Parallel cable, BLUETOOTH (IEEE 802.15.1), IR (infrared), ETHERNET (IEEE 802.3) or any other connection, either wired or wireless. The synchronization server automatically identifies the device and matches it with an available customer order, removing it from the queue so that other synchronization servers do not duplicate the order. To the extent possible, the synchronization server also automatically reads the device serial number and other identifying information and associates it with the customer order. If this is not possible, for example, if the device does not provide an interface to read its serial number, a bar code reader or similar device may collect the information.

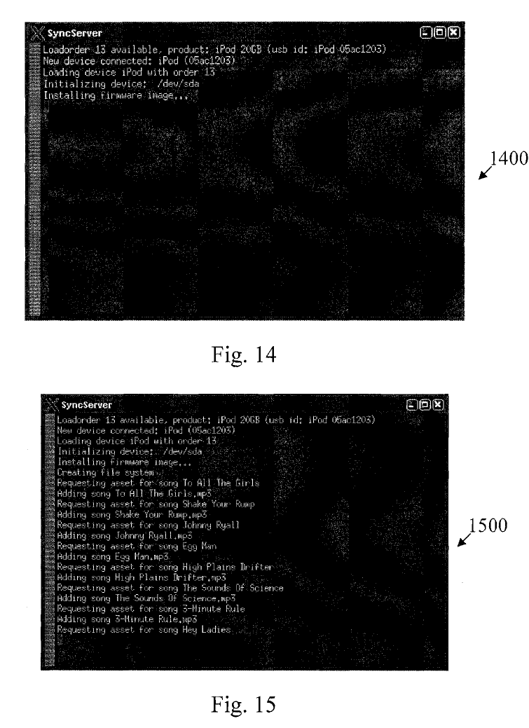

After the device is coupled to the synchronization server, the device is prepared for the loading of media and for customer use. Depending on the device, this may include initializing the storage medium, installing firmware or software on the device, updating or patching existing software, setting configurable options, such as the owner name and/or playback settings, or configuring DRM. FIG. 14 is a screen shot 1400 from the display of a synchronization server showing: device automatically detected, drive initialized and firmware being installed.

The synchronization server requests the media assets for the device in a format that is consistent with the device requirements and the customer's configuration and installs the media on the device.

For each asset, the synchronization server makes a request to any asset server which will return the media, either by returning a pre-cached version of the asset or by generating the asset by converting it from the source format to the requested format. If the asset is cached, the asset or a pointer to the asset is returned to the requestor. If the asset is not cached, the source asset is read from a central repository or a derivative asset may be read from an asset server. For example, if an asset is requested with DRM applied, the asset server receiving this request may avoid the resource requirements of regenerating the asset by pulling the asset in the correct format but without the DRM from another asset server, applying the DRM to the asset and then returning the new asset. This process is recursive, so an asset being converted to a complex format may be transferred from multiple asset servers to prepare the final asset. FIG. 15 is a screen shot 1500 from the display of a synchronization server showing the synchronization server requesting assets from asset servers.

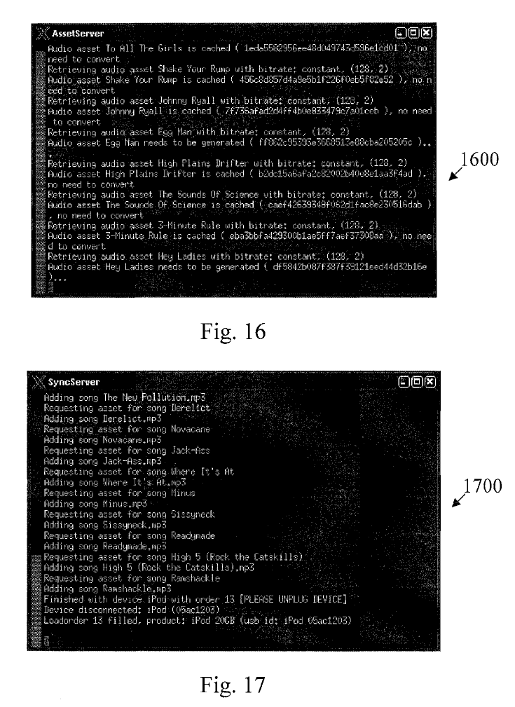

FIG. 16 is a screen shot 1600 from the display of an asset server showing examples of assets that are cached and needing generation. The assets are typically cached locally, on the asset server. In an alternative embodiment, a central caching repository is provided where all asset servers cache their assets or a subset of their assets.

An optimization to this process involves keeping a database of the cached assets and the asset servers that have them, so a request can be directed to the asset server most likely to have a cached version of the asset.

Once all media has been installed on the device, the final preparations are applied. Final preparations may include at least one of:
updating the device's database;
deleting temporary files;
reconfiguring settings specific to connecting to the synchronization server;
validating the media integrity through checksums or some other mechanism, confirming the device matches the order; and
performing a general quality assurance check.

FIG. 17 is a screen shot 1700 of the display from a synchronization server showing a completed order.

Device is Shipped to Customer

The device, now loaded with the media assets requested by the customer, is detached from the synchronization station, packaged (or re-package in the original packaging), and physically shipped to the customer. The vendor may add its own brand to the device to indicate the value-added nature of the pre-loading service. For example, the vendor may add a “Pre-loaded by Hotpods” sticker to device. Otherwise, the device is preferably shipped in the original packaging materials. The Customer receives the device, pre-loaded with all of their media.

The system and method of the invention have been developed with the following design principles in mind:
content delivery is preferably highly scalable;
the system will preferably work with foreseeable content;
the system will preferably work with foreseeable content;
the system will protect copyright;
the software will preferably be platform independent, being built with components that will run on most hardware;
the system will preferably be modular, so that major components, such as asset conversion tools, are easily replaced.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method for pre-loading digital media players comprising the steps of:
storing digital media assets owned by a customer of a vendor by said vendor;
receiving from the customer an order specifying which of said stored digital assets are to be loaded onto a digital media player by said vendor prior to delivery of said media player to said customer; and
delivering said media player to said customer by said vendor with said specified stored digital media assets pre-loaded onto said digital media player.

2. The method of claim 1, further comprising the step of:
receiving a purchase request from said customer for said digital media player by said vendor.

3. The method of claim 1, wherein said step of storing digital media assets comprises the steps of:
over an interactive network connection, providing means for authenticating said digital media assets owned by said customer substantially at the time said customer makes a request to purchase said digital media player;
after authentication, copying said owned digital media assets by said vendor, by means of said interactive network connection from a storage medium provided by said customer; and
storing said copied digital assets to an asset server.

4. The method of claim 3, wherein authenticating said digital media assets comprises the steps of:
using challenge/response authentication with a central server, verifying that said digital assets are authentic; and
associating said digital assets with an account assigned to said customer.

5. The method of claim 1, wherein said step of receiving an order from the customer comprises the steps of:
displaying a list of stored digital assets owned by said customer;
providing means for specifying by said customer which of said stored digital assets are to be loaded onto said digital media player, whereby said customer selects at least one of said digital assets from said displayed list; and
receiving said order at a central server by said vendor.

6. The method of claim 1, further comprising the step of:
allowing customers to select new digital assets to purchase and include with said digital media player.

7. The method of claim 7, further comprising the step of:
providing additional digital assets for customer purchase through third parties.

8. The method of claim 1, wherein said step of delivering said media player to said customer by said vendor comprises the steps of:
obtaining a digital media player of a type selected by said customer;
preparing said selected digital media player for use;
loading specified digital assets onto said selected digital media player; and
shipping said pre-loaded digital media player to said customer.

9. The method of claim 9, wherein said step of obtaining a digital media player comprises either of the steps of:
removing a digital media player of a type selected by said customer from said vendor's inventory; and
acquiring a digital media player of a type selected by said customer from a third party.

10. The method of claim 9, wherein said step of preparing said digital media player for use comprises any of the steps of:
connecting said digital media player to a synchronization server;
matching said digital media player with said customer's order, wherein device identifying information is associated to said customer's order;
initializing a storage medium on said digital media player;
installing any of firmware and software on said digital media player;
any of updating and patching existing software;
setting configurable options; and
configuring DRM (digital rights management).

11. The method of claim 10, wherein the step of loading specified digital assets onto said selected digital media player comprises any of the steps of:
requesting digital assets by said synchronization server for said digital media player in a format consistent with player requirements and customer configuration from an asset server;
loading said requested digital assets onto said digital media player; and
applying final preparations, wherein applying final preparations includes any of the steps of:
updating the digital media player's database;
deleting temporary files;
reconfiguring settings related to connecting to said synchronization server;
validating media integrity; and
performing a quality insurance check.

12. The method of claim 11, further comprising any of the steps of:
returning a pre-cached version of a requested digital asset by said asset server, wherein either the asset or a pointer to the asset is returned;
generating a requested asset by converting from a source format to a format requested;
reading a source asset from a central repository; and
reading a derivative asset from an asset server.

13. The method of claim 11, further comprising either of the steps of:
caching said assets locally on said asset server; and
providing a central caching repository wherein a plurality of asset servers cache either all or a subset of their digital assets.

14. The method of claim 8, wherein the step of shipping said pre-loaded digital media player to said customer comprises any of the steps of:
branding said digital media player by said vendor; and
shipping said device in original packaging materials;
whereby said customer receives said digital media device, pre-loaded with said specified digital assets.

15. A system for pre-loading digital media players comprising:
at least one asset server for providing digital assets processed for loading; and
at least one synchronization server for retrieving digital assets specified by a load order and loading said retrieved assets into a storage means associated with a purchased digital device.

16. The system of claim 15, further comprising:
at least one web server, said web server comprising:
means for purchasing said media device;
means for specifying said load order; and
means for authenticating said digital assets specified by said load order.

17. The system of claim 15, further comprising:
at least one database for storing customer data; and
at least one database for storing load orders.

18. The system of claim 15, further comprising:
at least one source assets repository for storing source assets prior to processing, wherein said at least one asset server retrieves said source assets from said at least one source assets repository.

19. The method of claim 15, further comprising any of:
a central cache for storing processed assets;
a local cache at said at least one asset server for storing processed assets; and
a cache hint server for monitoring which asset servers have previously processed assets cached locally.

20. The method of claim 15, further comprising any of:
means for connecting said digital device to said at least one synchronization server;
means for matching a digital device with a customer's order;
means for initializing a storage medium on said digital device;
means for installing any of firmware and software on said digital device;
means for updating and patching existing software on said digital device;
means for setting configurable options on said digital device;
means for configuring DRM (digital rights management) for said specified assets;
means for branding said digital device by said vendor; and
means for shipping said device in original packaging materials.
